(19) United States
(12) Patent Application Publication
(10) Pub. No.: US 2011/0211452 A1
(43) Pub. Date: Sep. 1, 2011

(54) RADIO BASE STATION AND RADIO COMMUNICATION METHOD

(75) Inventors: Keiji Murakami, Yokohama-shi (JP); Kyoko Fujito, Yokohama-shi (JP); Hirokazu Matsunami, Yokohama-shi (JP)

(73) Assignee: KYOCERA CORPORATION, Kyoto-shi, Kyoto (JP)

(21) Appl. No.: 13/126,341

(22) PCT Filed: Nov. 4, 2009
(86) PCT No.: PCT/JP2009/068840

§ 371 Date: Apr. 27, 2011

(30) Foreign Application Priority Data
Nov. 4, 2008 (JP) 2008-283750
Nov. 4, 2008 (JP) 2008-283751

(51) Int. Cl. H04W 36/00; H04W 24/00

(52) U.S. Cl. 370/237; 370/331

(57) ABSTRACT

A radio base station, comprising a DAP/RLSE/FLSE judging unit configured to judge whether the radio base station functions as both RLSE and FLSE, an application judging unit configured to judge whether the application running on the radio terminal is a specific application, and a handover instruction transmission unit configured to transmit a handover instruction to the radio terminal to handover either the RLSE or FLSE to another radio base station, when it is determined that the radio base station functions both as RLSE and FLSE and the running application is not the specific application.

### TECHNICAL FIELD

The present invention relates to a radio base station and a radio communication method used in a radio communication system in which different radio base stations can serve as a radio communication partner of a radio terminal in an uplink and a radio communication partner of the radio terminal in a downlink.

### BACKGROUND ART

In general, in a radio communication system, a same radio base station serves as a radio communication partner (hereinafter referred to as an “uplink radio communication partner”) of a radio terminal in an uplink from the radio terminal to a communication network and a radio communication partner (hereinafter referred to as a “downlink radio communication partner”) of the radio terminal in a downlink from the communication network to the radio terminal.

In recent years, provision of a radio communication system in which different radio base stations can serve as an uplink radio communication partner and a downlink radio communication partner has been studied to improve degree of freedom in selecting a radio communication partner of a radio terminal (see Non-Patent Document 1). With use of such a radio communication system, a radio base station suitable as an uplink radio communication partner and a radio base station suitable as a downlink radio communication partner can be selected separately, depending on radio quality (RSSI, CINR or the like). Thus, radio communications of higher quality can be provided.

### CITATION LIST

### Non-Patent Document

Non-Patent Document 1: Overview for Ultra Mobile Broadband (UMB) Air Interface Specification (3GPP2 C.S0084-000-0)

### SUMMARY OF THE INVENTION

However, in a radio communication system in which different radio base stations can serve as an uplink radio communication partner and a downlink radio communication partner, there are problems to be described hereinafter, if an uplink radio communication partner and a downlink radio communication partner are selected only depending on radio communication.

For example, there is a case where a radio terminal is running a real-time application requiring low delay, while communicating with a same radio base station in the uplink and the downlink. In this situation, if the radio terminal hands over the uplink radio communication partner or the downlink radio communication partner to another radio base station, communication delay occurs with the aforementioned handover. Furthermore, in an application which uses a header compression protocol, header compression may not function well if an uplink radio communication partner and a downlink radio communication partner are different.

As such, in a radio communication system in which different radio base stations can serve as an uplink radio communication partner and a downlink radio communication partner, there is a problem that a failure may occur depending on an application run by a radio terminal if the uplink radio communication partner and the downlink radio communication partner are different radio base stations.

In addition, for a radio terminal which is located close to a radio base station, it is preferable in terms of radio quality that the radio base station serves as both of an uplink radio communication partner and a downlink radio communication partner. On the one hand, if there is much traffic being transmitted and received through the radio base station, much communication resources in the uplink or downlink are consumed. In this case, it is not preferable in terms of communication resources that the radio base station serves as both the uplink and downlink radio communication partners of the radio terminal. That is to say, there is a problem that a radio base station cannot normally continue the service when communication resources in the uplink or downlink fall short.

Hence, an objective of the present invention is to provide a radio base station and a radio communication method capable of avoiding a failure which may occur because an uplink radio communication partner and a downlink radio communication partner of a radio terminal are different radio base stations.

In order to solve the problems described above, the present invention has the following characteristics. First of all, according to a first characteristic of the present invention, there is provided a radio base station (radio base station 1A) that performs radio communications with a radio terminal (radio terminal 2) in a radio communication system (radio communication system 10) allowing different radio base stations to serve as an uplink radio communication partner which is a radio communication partner of the radio terminal in an uplink, and a downlink radio communication partner which is a radio communication partner of the radio terminal in a downlink, the radio base station comprising: an instruction transmitter (handover instruction transmitter 126) configured to transmit to the radio terminal a handover instruction to handover any one of the uplink radio communication partner and the downlink radio communication partner to another radio base station if the radio base station functions as the uplink radio communication partner and the downlink radio communication partner, and also if a running application which is run at the radio terminal and involves radio communications with the radio base station is not a specific application, wherein the instruction transmitter is configured to omit transmission of the handover instruction if the radio base station functions as the uplink radio communication partner and the downlink radio communication partner, and also if the running application is the specific application.

According to such a characteristic, if the radio base station functions as the uplink radio communication partner and the downlink radio communication partner, and if the running application is not the specific application, the instruction transmitter transmits to the radio terminal the handover instruction to handover any one of the uplink radio communication partner and the downlink radio communication partner to another radio base station. Consequently, for an application for which no failure occurs even when different radio base stations can serve as an uplink radio communication partner and a downlink radio communication partner, different radio base stations can serve as the uplink radio communication partner and the downlink radio communication partner. On the one hand, the instruction transmitter omits transmission of the handover instruction when the running application is a specific application, i.e., the application in which a failure occurs if the uplink radio communication partner and the downlink radio communication partner are different radio base stations. Thus, the application failure can be avoided.

Thus, with the radio base station according to the above characteristic, a failure which occurs in a specific application if an uplink radio communication partner and a downlink radio communication partner are different radio base stations can be avoided, while allowing the different radio base stations to be the uplink radio communication partner and the downlink radio communication partner of a radio terminal.

A second characteristic of the present invention is according to the first characteristic of the present invention and is summarized in that: if the radio base station functions as the uplink radio communication partner and the downlink radio communication partner and also if the running application is not the specific application, the instruction transmitter is configured to transmit to the radio terminal an uplink handover instruction to handover the uplink radio communication partner to another radio base station as the handover instruction when an uplink traffic value indicating an amount of traffic being transmitted and received through the radio base station in the uplink exceeds a predetermined value for congestion in the uplink.

A third characteristic of the present invention is according to the first characteristic of the present invention and is summarized in that the radio base station further comprising: an uplink threshold comparator (threshold comparator 125) configured to, when the uplink traffic value exceeds the predetermined value, compare the uplink traffic value with an uplink threshold for a type of the specific application if the radio base station functions as the uplink radio communication partner and the downlink radio communication partner, and also if the running application is the specific application, wherein the instruction transmitter is configured to omit transmission of the uplink handover instruction if the uplink traffic value does not exceed the uplink threshold, and the instruction transmitter is configured to transmit the uplink handover instruction to the radio terminal if the uplink traffic value exceeds the uplink threshold.

A fourth characteristic of the present invention is according to the first characteristic of the present invention and is summarized in that: if the radio base station functions as the uplink radio communication partner and the downlink radio communication partner and also if the running application is not the specific application, the instruction transmitter is configured to transmit to the radio terminal a downlink handover instruction to handover the downlink radio communication partner to another radio base station as the handover instruction when a downlink traffic value indicating an amount of traffic being transmitted from the radio base station in the downlink exceeds a predetermined value for congestion in the downlink.

A fifth characteristic of the present invention is according to the fourth characteristic of the present invention and is summarized in that the radio base station further comprising: a downlink threshold comparator (threshold comparator 125) configured to, when the downlink traffic value exceeds the predetermined value, compare the downlink traffic value with a downlink threshold for a type of the specific application if the radio base station functions as the uplink radio communication partner and the downlink radio communication partner, and also if the running application is the specific application, wherein the instruction transmitter is configured to omit transmission of the downlink handover instruction if the downlink traffic value does not exceed the downlink threshold, and the instruction transmitter is configured to transmit the downlink handover instruction to the radio terminal if the downlink traffic value exceeds the downlink threshold.

A sixth characteristic of the present invention is according to the first characteristic of the present invention and is summarized in that: the instruction transmitter is configured to transmit the handover instruction to the radio terminal if the radio base station functions as the uplink radio communication partner and the downlink radio communication partner, if the running application is not the specific application, and also if there exists a handover target radio base station which is to serve as a handover target when the radio terminal hands over the uplink radio communication partner or the downlink radio communication partner.

A seventh characteristic of the present invention is according to the first characteristic of the present invention and is summarized in that: the instruction transmitter is configured to transmit the handover instruction to the radio terminal if the radio base station functions as the uplink radio communication partner, the downlink radio communication partner, and an anchor base station, and also if the running application is not the specific application, and the anchor base station is a radio base station which receives data addressed to the radio terminal from a communication network (IP network 4 and network gateway 3) in the downlink not through another radio base station.

An eighth characteristic of the present invention is according to the first characteristic of the present invention and is summarized in that: the specific application includes at least one of: an application using a header compression protocol; a non-voice real-time application requiring lower delay than a data application; and a voice real-time application requiring lower delay than the non-voice real-time application.

According to a ninth characteristic of the present invention, there is provided a radio communication method performed by a radio base station that performs radio communications with a radio terminal in a radio communication system allowing different radio base stations to serve as an uplink radio communication partner which is a radio communication partner of the radio terminal in an uplink, and a downlink radio communication partner which is a radio communication partner of the radio terminal in a downlink, the radio communication method comprising the steps of: transmitting to the radio terminal a handover instruction to handover any one of the uplink radio communication partner and the downlink radio communication partner to another radio base station if the radio base station functions as the uplink radio communication partner and the downlink radio communication partner, and also if a running application which is run at the radio terminal and involves radio communications with the radio base station is not a specific application; and omitting transmission of the handover instruction if the radio base station functions as the uplink radio communication partner and the downlink radio communication partner, and also if the running application is the specific application.

According to a tenth characteristic of the present invention, there is provided a radio base station (radio base station 1A) that performs radio communications with a radio terminal (radio terminal 2) in a radio communication system (radio communication system 10) allowing different radio base stations to serve as an uplink radio communication partner which is a radio communication partner of the radio terminal in an uplink, and a downlink radio communication partner which is a radio communication partner of the radio terminal in a downlink, the radio base station comprising: an instruction transmitter (handover instruction transmitter 126) configured to transmit to the radio terminal an uplink handover instruction to handover the uplink radio communication partner to another radio base station, if an uplink traffic value indicating an amount of traffic being transmitted and received through the radio base station in the uplink exceeds a predetermined value for congestion in the uplink, and also if the radio base station functions as the uplink radio communication partner and the downlink radio communication partner.

With such a radio base station, if congestion in the uplink occurs, traffic in the uplink is reduced and shortage of communication resources in the uplink is alleviated by the instruction transmitter transmitting the uplink handover instruction to the radio terminal, and thus service in the uplink can be continued normally.

An eleventh characteristic of the present invention is according to the tenth characteristic of the present invention and is summarized in that: the uplink traffic value is the number of all radio terminals for which the radio base station serves as the uplink radio communication partner.

A twelfth characteristic of the present invention is according to the tenth characteristic of the present invention and is summarized in that: the uplink traffic value is an uplink throughput which is an amount of traffic per unit time transmitted to a communication network through the radio base station from all radio terminals for which the radio base station serves as the uplink radio communication partner.

A thirteenth characteristic of the present invention is according to the tenth characteristic of the present invention and is summarized in that: the instruction transmitter is configured to transmit the uplink handover instruction to the radio terminal, if there exists a handover target radio base station which is to serve as a handover target when the radio terminal hands over the uplink radio communication partner, if the uplink traffic value exceeds the predetermined value, and also if the radio base station functions as the uplink radio communication partner and the downlink radio communication partner.

A fourteenth characteristic of the present invention is according to the tenth characteristic of the present invention and is summarized in that: the instruction transmitter is configured to transmit the uplink handover instruction to the radio terminal if the uplink traffic value exceeds the predetermined value, and also if the radio base station functions as the uplink radio communication partner, the downlink radio communication partner, and an anchor base station, and the anchor base station is a radio base station which receives data addressed to the radio terminal from a communication network in the downlink not through another radio base station.

According to a fifteenth characteristic of the present invention, there is provided a radio base station (radio base station 1A) that performs radio communications with a radio terminal (radio terminal 2) in a radio communication system (radio communication system 10) allowing different radio base stations to serve as an uplink radio communication partner which is a radio communication partner of the radio terminal in an uplink, and a downlink radio communication partner which is a radio communication partner of the radio terminal in a downlink, the radio base station comprising: an instruction transmitter (handover instruction transmitter 126) configured to transmit to the radio terminal a downlink handover instruction to handover the downlink radio communication partner to another radio base station, if a downlink traffic value indicating an amount of traffic being transmitted from the radio base station in the downlink exceeds a predetermined value for congestion in the downlink, and also if the radio base station functions as the uplink radio communication partner and the downlink radio communication partner.

With such a radio base station, if congestion in the downlink occurs, traffic in the downlink is reduced and shortage of communication resources in the downlink is alleviated by the instruction transmitter transmitting the downlink handover instruction to the radio terminal, and thus service in the downlink can be continued normally.

A sixteenth characteristic of the present invention is according to the fifteenth characteristic of the present invention and is summarized in that: the downlink traffic value is the number of all radio terminals for which the radio base station serves as the downlink radio communication partner.

A seventeenth characteristic of the present invention is according to the fifteenth characteristic of the present invention and is summarized in that: the instruction transmitter is configured to transmit the downlink handover instruction to the radio terminal, if there exists a handover target radio base station which is to serves as a handover target when the radio terminal hands over the downlink radio communication partner, if the downlink traffic value exceeds the predetermined value, and also if the radio base station functions as the uplink radio communication partner and the downlink radio communication partner.

An eighteenth characteristic of the present invention is according to the fifteenth characteristic of the present invention and is summarized in that: the instruction transmitter is configured to transmit the downlink handover instruction to the radio terminal if the downlink traffic value exceeds the predetermined value, and also if the radio base station functions as the uplink radio communication partner, the downlink radio communication partner, and an anchor base station, and the anchor base station is a radio base station which receives data addressed to the radio terminal from a communication network in the downlink not through another radio base station.

According to a nineteenth characteristic of the present invention, there is provided a radio communication method performed by a radio base station that performs radio communications with a radio terminal in a radio communication system allowing different radio base stations to serve as an uplink radio communication partner which is a radio communication partner of the radio terminal in an uplink, and a downlink radio communication partner which is a radio communication partner of the radio terminal in a downlink, the radio communication method comprising the steps of: transmitting to the radio terminal an uplink handover instruction to handover the uplink radio communication partner to another radio base station, if an uplink traffic value indicating an amount of traffic being transmitted and received through the radio base station in the uplink exceeds a predetermined value for congestion in the uplink, and also if the radio base station functions as the uplink radio communication partner and the downlink radio communication partner.

According to a twentieth characteristic of the present invention, there is provided a radio communication method performed by a radio base station that performs radio communications with a radio terminal in a radio communication system allowing different radio base stations to serve as an uplink radio communication partner which is a radio communication partner of the radio terminal in an uplink, and a downlink radio communication partner which is a radio communication partner of the radio terminal in a downlink, the radio communication method comprising the steps of: transmitting to the radio terminal a downlink handover instruction to handover the downlink radio communication partner to another radio base station, if a downlink traffic value indicating an amount of traffic being transmitted from the radio base station in the downlink exceeds a predetermined value for congestion in the downlink, and also if the radio base station functions as the uplink radio communication partner and the downlink radio communication partner.

### BRIEF DESCRIPTION OF THE DRAWINGS

FIG. 1 is an overall schematic configuration diagram of a radio communication system according to an embodiment of the present invention.

FIG. 2 is a view showing a state in which an RLSE and an FLSE have been handed over.

FIG. 3 is a view showing a state in which the FLSE (and a DAP) and the RLSE are different radio base stations.

FIG. 4 is a schematic configuration diagram showing a configuration of a radio base station according to an embodiment of the present invention.

FIG. 5 is a conceptual diagram for illustrating thresholds for application types.

FIG. 6 is a flow chart showing operation flow of an RLSE handover operation to be performed in a radio base station according to the embodiment of the present invention.

FIG. 7 is a flow chart showing operation flow of an FLSE handover operation to be performed in a radio base station according to the embodiment of the present invention.

### DESCRIPTION OF EMBODIMENTS

A radio communication system according to an embodiment of the present invention will be described hereinafter with reference to the drawings. Specifically, (1) an overall schematic configuration, (2) a configuration of a radio base station, (3) an operation of a radio base station, (4) advantageous effects, and (5) other embodiments will be described. In the following description of the drawings of embodiments, a same or similar reference numeral is given to a same or similar part.

(1) Overall Schematic Configuration

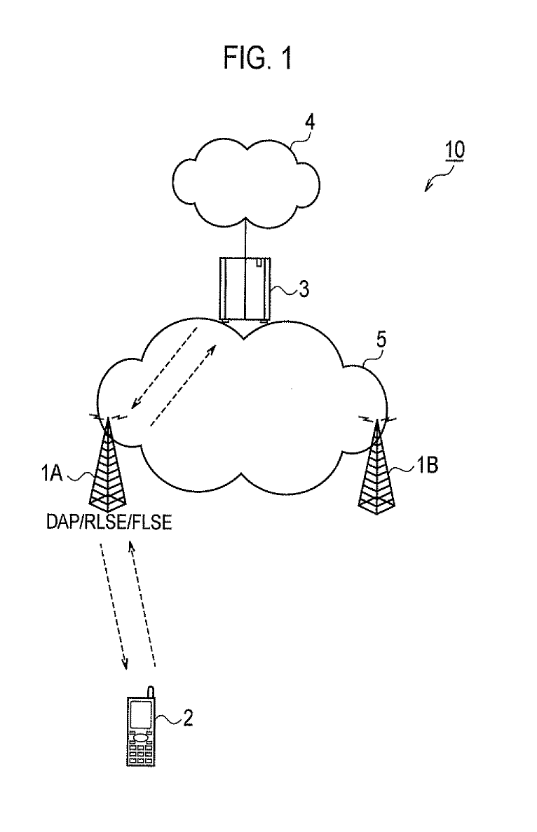

FIG. 1 is an overall schematic configuration diagram of a radio communication system 10 according to the present embodiment.

As shown in FIG. 1, a radio communication system 10 includes a radio base station 1A, a radio base station 15, a radio terminal 2, a network gateway 3, and an IP network 4 (communication network). In the embodiment, the radio communication system 10 has a configuration based on 3GPP2 (Third Generation Partnership Project 2) UMB (UltraMobile Broadband) Air Interface (hereinafter simply referred to as “UMB system”), which is one of wide-area IP broadband systems capable of high-speed communications.

The radio base station 1A, the radio base station 15, and the network gateway 3 are wire-connected through a backbone network 5, which is a wired communication network. The radio base station 1A and the radio base station 1B can communicate with the IP network 4 such as the Internet or the like, through the network gateway 3. The radio base station 1A and the radio base station 1B can wire-communicate with each other through the backbone network 5. The radio base station 1A performs radio communications with a radio terminal 2 located in a communication area of the radio base station 1A. Although FIG. 1 shows only one radio terminal 2, in some cases, a large number of radio terminals 2 may perform radio communications with the radio base station 1A.

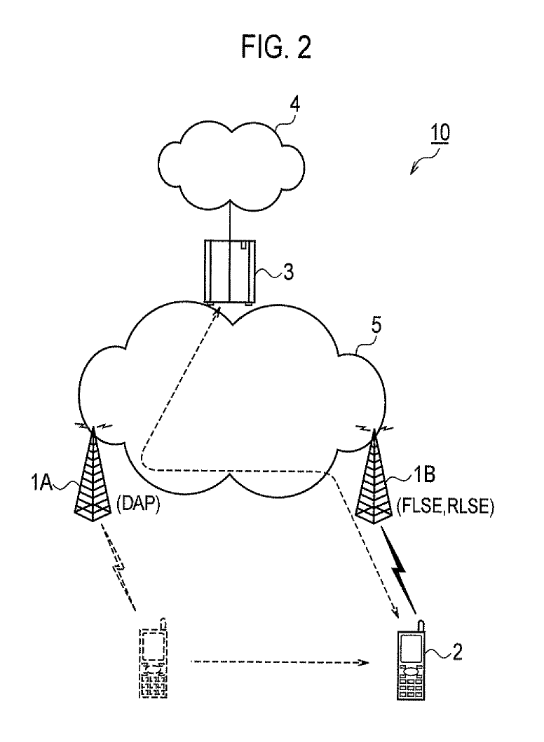

The radio terminal 2 performs so-called a handover in which a radio communication partner is handed over to a radio base station of higher radio quality. In the UMB system, a method is contemplated in which at the time of handover, a handover source radio base station serves as a relay station (anchor) with the network gateway 3, and transfers data, which has not been sent to the radio terminal 2, from the handover source radio base station to a handover target radio base station by utilizing communications among base stations (see FIG. 2). Such a method can provide a handover with less packet loss.

In the UMB system, a radio base station which serves as an anchor base station for receiving data addressed to the radio terminal 2 from the network gateway 3 in a downlink not through another radio base station is designated as a DAP (Data Attachment Point), a radio base station which functions as an uplink radio communication partner of the radio terminal 2 is designated as an RLSE (Reverse Link Serving eBS), and a radio base station which functions as a downlink radio communication partner of the radio terminal 2 is designated as an FLSE (Forward Link Serving eBS).

FIG. 2 shows a state in which the radio terminal 2 has moved to a communication area of the radio base station 1B, and handed over the RLSE and the ELSE from the radio base station 1A to the radio base station 1B.

It is a vendor matter when to handover the DAP from the radio base station 1A to the radio base station 1B after handing over the RLSE and the FLSE from the radio base station 1A to the radio base station 1B. By way of example, a method for handing over the DAP to the radio base station 1B after a certain period of time has elapsed since a handover, a method for handing over the DAP to the radio base station 1B when there is no longer user data traffic being transmitted and received by the radio base station 1A, a method for handing over the DAP to the radio base station 1B when a transfer to the radio base station 1B of data not processed/transmitted by the radio base station 1A is complete, or the like is contemplated.

On the one hand, the example of FIG. 1 shows a state in which the radio terminal 2 remains stationary or some period of time has elapsed since the radio terminal 2 has performed a handover, and the same radio base station 1A acts as the DAP, the RLSE and the FLSE of the radio terminal 2. In the embodiment, the state shown in FIG. 1 will be mainly described.

In FIG. 1 and FIG. 2, although the same radio base station functions as the RLSE and the FLSE, in the radio communication system 10, different radio base stations may serve as the FLSE and the RLSE during a handover or the like. That is to say, different radio base stations can serve as a radio communication partner of the radio terminal 2 in an uplink and a radio communication partner of the radio terminal 2 in the downlink.

As an optimal radio path varies for each FLSE/RLSE, depending on radio conditions, it is likely that implementation of communications by separate paths for each of FLSE/FLSE could provide higher quality service at a higher speed. In addition, handovers are roughly divided into two types: base station-led handovers and terminal-led handovers. When a base station-led handover is performed in communications in the uplink, magnitude of received power or interfering wave from the radio terminal 2 often becomes an important criterion to perform a handover.

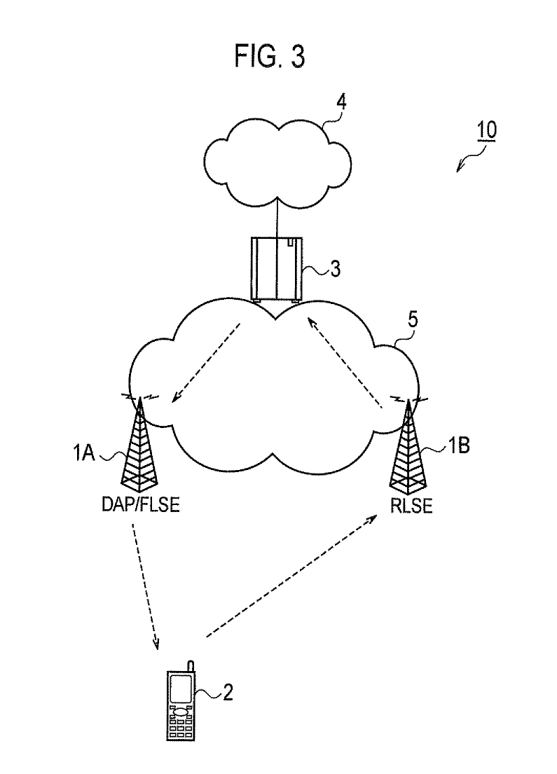

FIG. 3 shows a state in which the radio base station 1A is the FLSE (and the DAP), the radio base station 1B is and the RLSE.

In the example of FIG. 3, the radio base station 1A receives downlink data from the network gateway 3 not through another radio base station, and transmits the received downlink data to the radio terminal 2. The radio base station 1B receives uplink data from the radio terminal 2, and transmits the received uplink data to the network gateway 3. In the UMB system, the form shown in FIG. 3 is referred to as RL Only Binding.

In the radio communication system 10, as a method for carrying IP packets of the radio terminal 2 to a network, IP tunneling technology represented by IETF RFC3931 Layer Two Tunneling Protocol-Version 3 (L2TPv3), and IETF RFC2784 Generic Routing Encapsulation (GRE) is adopted. In the UMB system, GRE is adopted as a user data bearer between the radio base station and the network gateway 3, while L2TPv3 is adopted as a user data bearer between a handover source radio base station and a handover target radio base station.

In the radio communication system 10, a header compression protocol such as RoHC (Robust Header Compression) or the like is used to reduce a ratio of headers to packets to be transmitted over radio links, that is to say, overhead.

In such a header compression protocol, during initial communications, a transmitting side transmits initialization packets and then compressed packets to a receiving side. The compressed packets contain compressed headers which have been compressed at a predetermined compression rate. The initialization packets contain headers of a lower compression rate than the predetermined compression rate mentioned above. The header compression rate in such initialization packets (IR packets) is zero. Based on the initialization packets received from the transmitting side, the receiving side generates header decoding information (context information) to be used for decoding the compressed headers. Then, the receiving side decodes the compressed headers contained in the compressed packets received from the transmitting side, by using the header decoding information. The receiving side updates the header decoding information according to the compressed headers contained in the compressed packets received from the transmitting side.

As such, in the header compression protocol, overhead can be reduced stepwise by increasing the header compression rate stepwise. However, when the radio terminal 2 which is running an application using the header compression protocol performs a handover, the following problem occurs. Specifically, in order to cause a handover target radio base station to generate header decoding information, the radio terminal 2 needs to transmit initialization packets with large overhead to the handover target base station immediately after the handover is performed, even though the radio terminal 2 has transmitted compressed packets to a handover source radio base station prior to a handover. Thus, it is not preferable that the radio terminal 2 which is running the application using the header compression protocol performs a handover.

(2) Configuration of Radio Base Station

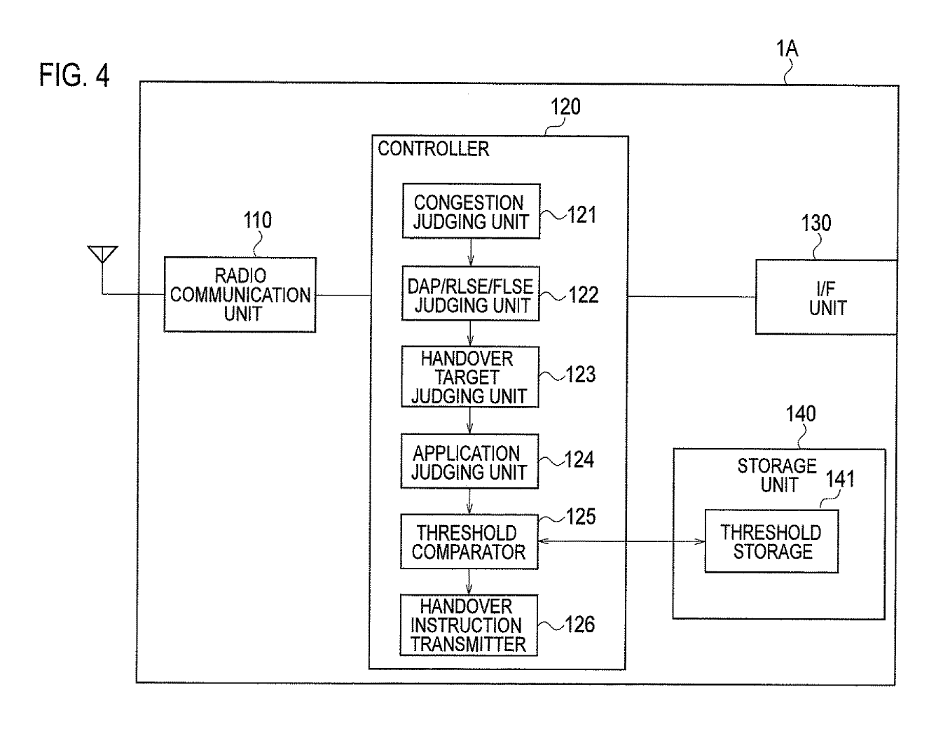

FIG. 4 is a schematic configuration diagram showing a configuration of the radio base station 1A. As a configuration of a radio base station 1B is similar to that of the radio base station 1A, a description of the configuration of the radio base station 1B will be omitted.

As shown in FIG. 4, the radio base station 1A includes a radio communication unit 110, a controller 120, an I/F unit 130, and a storage unit 140.

The radio communication unit 110 includes an LNA, a power amplifier, an up-converter, a down-converter, and the like, and performs transmission and reception of radio signals. The I/F unit 130 is wire-connected to the radio base station 15 and the network gateway 3 or the like through the backbone network 5.

The controller 120 is configured by a CPU, for example, and controls various functions with which the radio base station 1A is provided. The storage unit 140 is configured by a memory, for example, and stores various types of information to be used in control at the radio base station 1A.

The controller 120 may have a function to manage a radio terminal which is performing radio communications with the radio base station 1A. The controller 120 manages a radio terminal using the radio base station 1A as the FLSE and a radio terminal using the radio base station 1A as the RLSE, and causes the storage unit 140 to store information of the radio terminals.

The controller 120 includes a congestion judging unit 121, a DAP/RLSE/FLSE judging unit 122, a handover target judging unit 123, an application judging unit 124, a threshold comparator 125, and a handover instruction transmitter 126.

The congestion judging unit 121 judges that congestion has occurred in an uplink when an uplink traffic value indicating an amount of traffic being transmitted and received through the radio base station 1A in the uplink exceeds a predetermined value. That is to say, the congestion judging unit 121 configures an uplink congestion judging unit.

As the uplink traffic value, either uplink throughput or the total number of RLSEs, for example, can be used.

The uplink throughput is an amount of traffic per unit time to be transmitted from all radio terminals using the radio base station 1A as the RLSE to the network gateway 3 through the radio base station 1A. The predetermined value noted above to be compared with the uplink throughput is set to a value close to a maximum transmittable band of the radio base station 1A.

The total number of RLSEs is the number of all radio terminals using the radio base station 1A as the RLSE. In fact, the larger the number of radio terminals which use the radio base station 1A as the RLSE is, the more the uplink traffic amount is, and thus it can be determined that uplink communication resources are short. The predetermined value noted above to be compared with the total number of RLSEs is set to a value close to a maximum number of RLSEs that can be held.

The congestion judging unit 121 judges that congestion has occurred in a downlink when a downlink traffic value indicating an amount of traffic being transmitted from the radio base station 1A in the downlink exceeds a predetermined value. That is to say, the congestion judging unit 121 configures a downlink congestion judging unit.

As the downlink traffic value, the total number of FLSEs, for example, can be used. The total number of FLSEs is the number all radio terminals using the radio base station 1A as the FLSE. In fact, the larger the number of radio terminals which use the radio base station 1A as the FLSE is, the more the downlink traffic amount is, and thus it can be determined that downlink communication resources are short. The predetermined value noted above to be compared with the total number of FLSEs is set to a value close to a maximum number of FLSEs that can be held.

The DAP/RLSE/FLSE judging unit 122 configures a function judging unit for judging whether or not the radio base station 1A functions as the RLSE and the FLSE. The DAP/RLSE/FLSE judging unit 122 may not only judge whether or not the radio base station 1A functions as the RLSE and the FLSE, but also whether or not the radio base station 1B operates as the DAP.

The handover target judging unit 123 judges whether or not there exists a handover target radio base station which is a handover target when the radio terminal 2 hands over the RLSE or the FLSE. In the UMB system, a handover target radio base station can be detected based on route information (route MAP) of the radio terminal 2 or neighbor discovery which is a procedure to detect a neighboring base station (see 3gpp2 UMB Architecture A.S0020 or C.S0084).

The application judging unit 124 judges whether or not a running application which is run by the radio terminal 2 and involves radio communications with the radio base station 1A is a specific application.

Now, specific applications include an application using a header compression protocol, a non-voice (other than voice) real-time application in which lower delay than data application is requested, and a voice real-time application in which lower delay than that in the non-voice real-time application is requested. In the embodiment, the application using the header compression protocol is a RoHC application using RoHC which is one of the header compression protocols.

The application judging unit 124 detects a running application depending on a communication session type which is set for the radio terminal 2. However, detection of a running application is not limited to such a detection method, and the running application may be detected from data to be transmitted/received to/from the radio terminal 2 (specifically, headers of packets or the like), or the running application may be detected during negotiation with the radio terminal 2.

When the congestion judging unit 121 judges that congestion has occurred in the uplink, and the application judging unit 124 judges that a running application is a specific application, the threshold comparator 125 compares an uplink traffic value (here, the total number of RLSEs) with an uplink threshold for a type of the specific application. That is to say, the threshold comparator 125 configures an uplink threshold comparator.

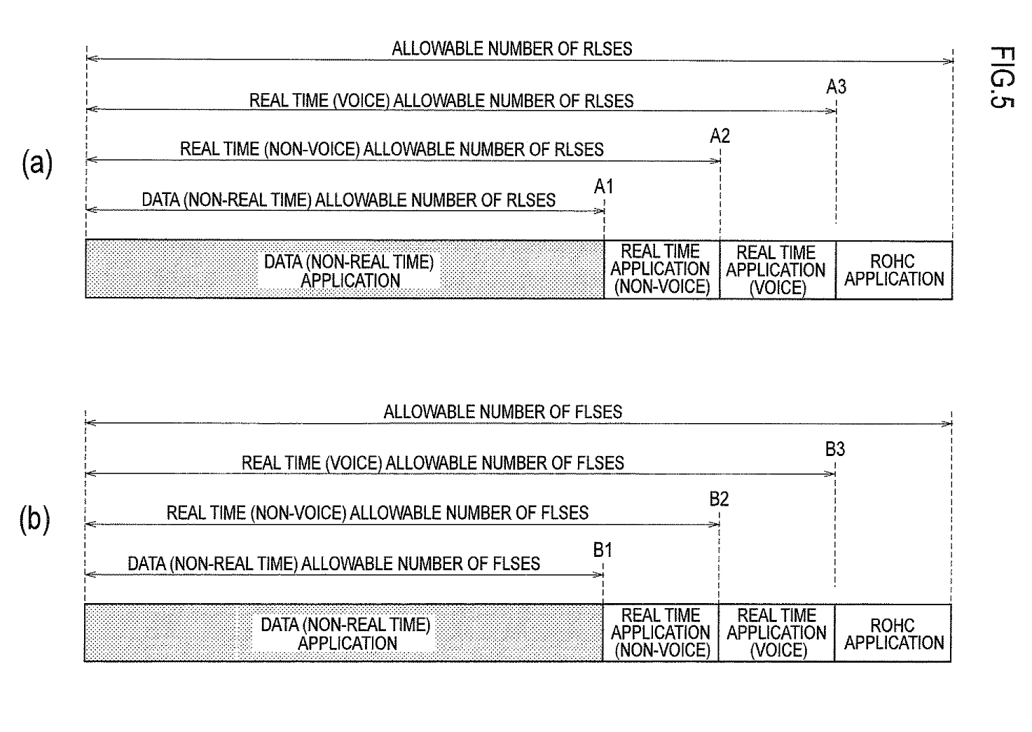

FIG. 5(a) is a conceptual diagram for illustrating uplink thresholds for types of specific applications. Information of the uplink threshold as shown in FIG. 5(a) has been stored in advance in a threshold storage 141 provided in the storage unit 140.

As shown in FIG. 5(a), an uplink threshold A1 is associated with an application type “non-voice real-time application”. An uplink threshold A2 is associated with an application type “voice real-time application”. An uplink threshold A3 is associated with an application type “RoHC application”. If the RLSE is handed over in the applications, a failure occurs as described above.

In the voice real-time application, when the RLSE is handed over, degradation (delay/jumpiness) of sound quality due to packet loss during a handover is caused. Similarly, in the non-voice real-time application (video real-time application, for example), when the RLSE is handed over, degradation of picture quality or of other services due to packet loss during a handover is caused.

On the one hand, in the data application, handing over of the RLSE or the FLSE is less likely to cause a failure compared with the RoHC application and the real-time application. Thus, when congestion occurs in the uplink, it is preferable to cause the radio terminal which runs the data application to handover the RLSE, until the total number of RLSEs reaches the uplink threshold A1.

When the total number of RLSEs exceeds the uplink threshold A1, the radio terminal which runs the non-voice real-time application is caused to handover the RLSE, in addition to the radio terminal which runs the data application.

When the total number of RLSEs exceeds the uplink threshold A2, the radio terminal which runs the voice real-time application is caused to handover the RLSE, in addition to the radio terminal which runs the data application and the radio terminal which runs the non-voice real-time application.

When the total number of RLSEs exceeds the uplink threshold A3, the radio terminal which runs the RoHC application is caused to handover the RLSE, in addition to the radio terminal which runs the data application, the radio terminals which runs the non-voice real-time application, and radio terminals which runs the voice real-time application.

As such, the radio terminal which runs the RoHC application is prevented from handing over the RLSE as much as possible.

In addition, when the congestion judging unit 121 judges that congestion has occurred in the downlink, and the application judging unit 124 judges that the running application is the specific application, the threshold comparator 125 compares a downlink traffic value (specifically, the total number of FLSEs) with the downlink threshold for a type of the specific application. In other words, the threshold comparator 125 configures a downlink threshold comparator.

FIG. 5(b) is a conceptual diagram for illustrating downlink thresholds for types of specific applications. Information of the downlink threshold as shown in FIG. 5(b) has been stored in advance in the threshold storage 141.

As shown in FIG. 5(b), a downlink threshold B1 is associated with an application type “non-voice real-time application”. A downlink threshold B2 is associated with an application type “voice real-time application”. A downlink threshold B3 is associated with an application type “RoHC application”. When congestion occurs in the downlink the radio terminal which runs the data application is caused to handover the ELSE, until the total number of FLSEs reaches the downlink threshold B1. When the total number of FLSEs exceeds the downlink threshold B1, the radio terminal which runs the non-voice real-time application is caused to handover the FLSE, in addition to the radio terminal which runs the data application.

When the total number of FLSEs exceeds the downlink threshold B2, the radio terminal which runs the voice real-time application is caused to handover the FLSE, in addition to the radio terminal which runs the data application and the radio terminal which runs the non-voice real-time application.

When the total number of FLSEs exceeds the downlink threshold B3, the radio terminal which runs the RoHC application is caused to handover the FLSE, in addition to the radio terminal which runs the data application, the radio terminals which runs the non-voice real-time application, and radio terminals which runs the voice real-time application.

The handover instruction transmitter 126 transmits to the radio terminal 2 a handover instruction to handover any of the RLSE or the FLSE to another radio base station, on the basis of at least one process result of the congestion judging unit 121, the DAP/RLSE/FLSE judging unit 122, the handover target judging unit 123, the application judging unit 124, and the threshold comparator 125. An operation to transmit a handover instruction will be described hereinafter.

(3) Operation of Radio Base Station

An operation of a radio base station 1A will be described in the order of (3.1) RLSE handover operation and (3.2) FLSE handover operation.

(3.1) RLSE Handover Operation

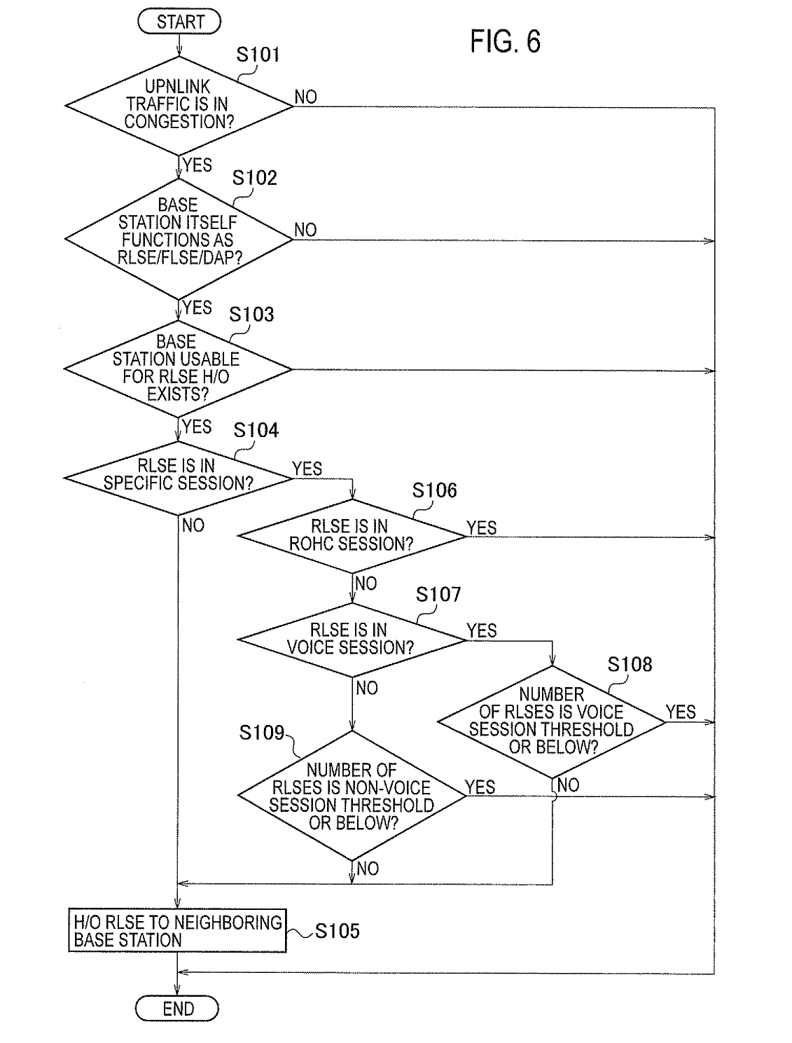

FIG. 6 is a flow chart showing operation flow of the RLSE handover operation to be performed in the radio base station 1A. In the operation flow, because of its close involvement in compression/decoding procedure in both downlink and uplink, the RLSE will not be handed over in the RoHC application. The operation flow is performed for each radio terminal which uses the radio base station 1A as the RLSE.

In Step S101, the congestion judging unit 121 judges whether or not an uplink traffic value exceeds a predetermined value. If the uplink traffic value exceeds the predetermined value, the congestion judging unit 121 judges that congestion has occurred in the uplink. If it is judged that congestion has occurred in the uplink, the process proceeds to Step S102.

In Step S102, the DAP/RLSE/FLSE judging unit 122 judges whether or not the radio base station 1A functions as the RLSE, the FLSE and the DAP of the radio terminal 2. When the radio base station 1A functions as the RLSE, the FLSE and the DAP of the radio terminal 2, it can be considered that the radio terminal 2 is unlikely to perform a handover. If it is judged that the radio base station 1 functions as the RLSE, the FLSE and the DAP of the radio terminal 2, the process proceeds to Step S103.

In Step S103, the handover target judging unit 123 judges whether or not there exists a handover target radio base station which serves as a handover target when the radio terminal 2 hands over the RLSE. If it is judged that the handover target radio base station exists, the process proceeds to Step S104.

In addition to such a judgment, if a plurality of handover target radio base stations exist, the handover target judging unit 123 may identify a radio base station with less uplink traffic amount and sufficient uplink communication resources, by utilizing communications among base stations, and select the radio base station as a candidate for an RLSE handover target.

In Step S104, the application judging unit 124 judges whether or not an uplink communication session with the radio terminal 2 is a session of a specific application. If it is judged that the uplink communication session is a session of the specific application, the process proceeds to Step S106.

On the other hand, if it is judged that the uplink communication session is not a session of the specific application, the process proceeds to Step S105. In Step S105, the handover instruction transmitter 126 transmits to the radio terminal 2 an RLSE handover instruction to handover the RLSE to a neighboring radio base station (radio base station 1B, or the like, for example).

The RLSE handover instruction may or may not specify an RLSE handover target radio base station. If the RLSE handover instruction specifies an RLSE handover target radio base station, the radio terminal 2 hands over the RLSE to the specified radio base station. If the RLSE handover instruction does not specify the RLSE handover target radio base station, the radio terminal 2 selects a radio base station of good radio quality and hands over the RLSE to the radio base station.

In Step S106, the application judging unit 124 judges whether or not an uplink communication session with the radio terminal 2 is a session of the RoHC application. If it is judged that the uplink communication session is not a session of the RoHC application, the process proceeds to Step S107.

In Step S107, the application judging unit 124 judges whether or not an uplink communication session with the radio terminal 2 is a session of the voice real-time application. If it is judged that the uplink communication session is a session of the voice real-time application, the process proceeds to Step S108. On the one hand, if it is judged that the uplink communication session is not a session of the voice real-time application, the process proceeds to Step S109.

In Step S108, the threshold comparator 125 compares the total number of RLSEs and the uplink threshold A2 for the voice real-time application. Based on the comparison result, if the total number of RLSEs exceeds the uplink threshold A2, the process proceeds to Step S105.

In Step S109, the threshold comparator 125 compares the total number of RLSEs and the uplink threshold A1 for the non-voice real-time application. Based on the comparison result, if the total number of RLSEs exceeds the uplink threshold A1, the process proceeds to Step S105.

(3.2) FLSE Handover Operation

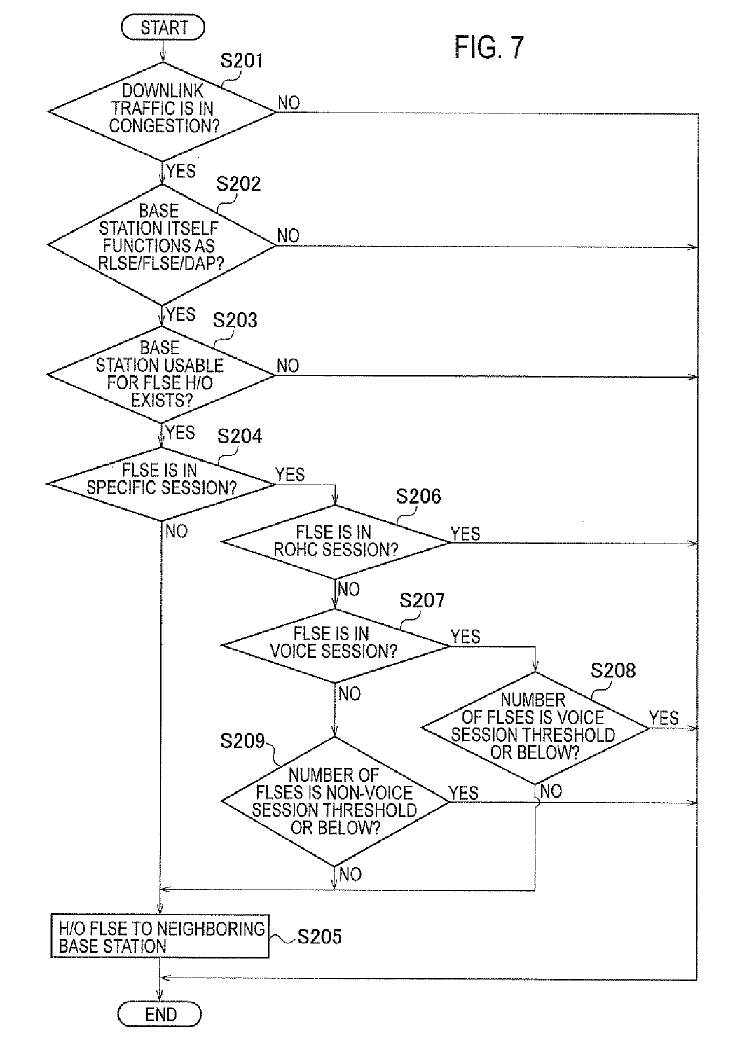

FIG. 7 is a flow chart showing operation flow of the FLSE handover operation to be performed in the radio base station 1A. In the operation flow, the ELSE will not be handed over in the RoHC application as in the RLSE handover operation. The operation flow is performed for each radio terminal which uses the radio base station 1A as the FLSE.

In Step S201, the congestion judging unit 121 judges whether or not a downlink traffic value exceeds a predetermined value. If the downlink traffic value exceeds the predetermined value, the congestion judging unit 121 judges that congestion has occurred in the downlink. If it is judged that congestion has occurred in the downlink, the process proceeds to Step S202.

In Step S202, the DAP/RLSE/FLSE judging unit 122 judges whether or not the radio base station 1A functions as the RLSE, the FLSE and the DAP of the radio terminal 2. If it is judged that the radio base station 1 functions as the RLSE, the FLSE and the DAP of the radio terminal 2, the process proceeds to Step S203.

In Step S203, the handover target judging unit 123 judges whether or not there exists a handover target radio base station which serves as a handover target when the radio terminal 2 hands over the FLSE. If it is judged that the handover target radio base station exists, the process proceeds to Step S204.

In addition to such a judgment, if a plurality of handover target radio base stations exist, the handover target judging unit 123 may identify a radio base station with less downlink traffic amount and sufficient downlink communication resources, by utilizing communications among base stations, and select the radio base station as a candidate for an FLSE handover target.

In Step S204, the application judging unit 124 judges whether or not a downlink communication session with the radio terminal 2 is a session of a specific application. If it is judged that the downlink communication session is a session of the specific application, the process proceeds to Step S206.

On the other hand, if it is judged that the downlink communication session is not a session of the specific application, the process proceeds to Step S205. In Step S205, the handover instruction transmitter 126 transmits to the radio terminal 2 an FLSE handover instruction to handover the FLSE to a neighboring radio base station (radio base station 1B, or the like, for example).

The FLSE handover instruction may or may not specify an ELSE handover target radio base station. If the ELSE handover instruction specifies an ELSE handover target radio base station, the radio terminal 2 hands over the FLSE to the specified radio base station. If the ELSE handover instruction does not specify the ELSE handover target radio base station, the radio terminal 2 selects a radio base station of good radio quality and hands over the ELSE to the radio base station.

In Step S206, the application judging unit 124 judges whether or not a downlink communication session with the radio terminal 2 is a session of the RoHC application. If it is judged that the downlink communication session is not a session of the RoHC application, the process proceeds to Step S207.

In Step S207, the application judging unit 124 judges whether or not a downlink communication session with the radio terminal 2 is a session of the voice real-time application. If it is judged that the downlink communication session is a session of the voice real-time application, the process proceeds to Step S208. On the one hand, if it is judged that the downlink communication session is not a session of the voice real-time application, the process proceeds to Step S209.

In Step S208, the threshold comparator 125 compares the total number of FLSEs and the downlink threshold B2 for the voice real-time application. Based on the comparison result, if the total number of FLSEs exceeds the downlink threshold B2, the process proceeds to Step S205.

In Step S209, the threshold comparator 125 compares the total number of FLSEs and the downlink threshold B1 for the non-voice real-time application. Based on the comparison result, if the total number of FLSEs exceeds the downlink threshold B1, the process proceeds to Step S205.

(4) Advantageous Effects

In the embodiment, when the radio base station 1A functions as the RLSE and the FLSE, and when a running application is not a specific application, the handover instruction transmitter 126 transmits the handover instruction to handover any of the RLSE or the FLSE to another radio base station, to the radio terminal 2.

Thus, for an application in which no failure occurs even when different radio base stations can serve as the RLSE and the FLSE, it is allowable that the RLSE and the FLSE are different radio base stations.

On the other hand, when the running application is a specific application, i.e., an application in which a failure is caused when the RLSE and the ELSE are different radio base stations, the handover instruction transmitter 126 omits transmission of the handover instruction. Thus, the failure can be avoided.

In the embodiment, when the congestion judging unit 121 judges that congestion has occurred in an uplink, and the DAP/RLSE/FLSE judging unit 122 judges that the radio base station 1A functions as the RLSE and the FLSE, the handover instruction transmitter 126 transmits an RLSE handover instruction to handover the RLSE to another radio base station, to the radio terminal 2.

As such, shortage of communication resources in the uplink is alleviated by transmitting the RLSE handover instruction to the radio terminal 2 if congestion has occurred in the uplink. Hence, the radio base station 1A can normally continue service in the uplink.

Then, the handover instruction transmitter 126 transmits the RLSE handover instruction if the application judging unit 124 judges that a running application is not a specific application, and thus the RLSE can be handed over to another radio base station while recognizing that the running application is not an application in which no failure occurs even when the RLSE and the FLSE are different radio base stations.

In addition, a radio path can be provided in a flexible manner depending on an application being run by the radio terminal 2 such as by not handing over the RLSE for the radio terminal 2 which is in RoHC communication, while actively handing over the RLSE for the radio terminal which is in data communication when the uplink congestion occurs.

In the embodiment, when an uplink traffic value does not exceed a threshold for a specific application, the instruction handover transmitter 126 omits transmission of an RLSE handover instruction, while it transmits the RLSE handover instruction when the uplink traffic value exceeds the threshold.

As this enables a judgment to be made on whether or not the RLSE handover instruction is transmitted depending on an uplink traffic value for every specific application, more sophisticated control of uplink congestion can be provided.

In the embodiment, when the congestion judging unit 121 judges that congestion has occurred in a downlink, and the DAP/RLSE/FLSE judging unit 122 judges that the radio base station 1A functions as the RLSE and the FLSE, the handover instruction transmitter 126 transmits as a handover instruction, an FLSE handover instruction to handover the FLSE to another radio base station, to the radio terminal 2.

As such, shortage of communication resources in the downlink is alleviated by transmitting the FLSE handover instruction to the radio terminal 2 if congestion has occurred in the downlink. Hence, the radio base station 1A can normally continue service in the downlink.

Then, the handover instruction transmitter 126 transmits the FLSE handover instruction if the application judging unit 124 judges that a running application is not a specific application, the FLSE can be handed over to another radio base station while recognizing that the running application is not an application in which no failure occurs even when RLSE and ELSE are different radio base stations.

In addition, a radio path can be provided in a flexible manner depending on an application being run by the radio terminal 2 such as by not handing over the FLSE for the radio terminal 2 which is in RoHC communication, while actively handing over the FLSE for the radio terminal which is in data communication when the downlink congestion occurs.

In the embodiment, when a downlink traffic value does not exceed a threshold for a specific application, the instruction handover transmitter 126 omits transmission of an FLSE handover instruction, while it transmits the FLSE handover instruction when the downlink traffic value exceeds the threshold.

As this enables a judgment to be made on whether or not the FLSE handover instruction is transmitted depending on a downlink traffic value for every specific application, more sophisticated control of downlink congestion can be provided.

In the embodiment, as the handover instruction transmitter 126 transmits the handover instruction when the handover target judging unit 123 judges that a handover target radio base station exists, it can be assured that radio communications of the radio terminal 2 continues thereafter. Thus, reliability of communications can be ensured.

In the embodiment, the handover instruction transmitter 126 transmits the handover instruction, when the DAP/RLSE/FLSE judging unit 122 judges that the radio base station 1A functions as the RLSE, the ELSE and the DAP.

When the radio base station 1A functions as the DAP of the radio terminal 2, it can be regarded that a long time has elapsed since a handover by the radio terminal 2. That is to say, for the radio terminal 2 which is moving (moving at a high speed), as a handover is performed depending on radio quality even when no handover instruction is transmitted, transmission of an unnecessary handover instruction can be prevented by omitting transmission of the handover instruction to such a radio terminal 2.

(5) Other Embodiments

As described above, the details of the present invention have been disclosed by using the embodiment of the present invention. However, it should not be understood that the description and drawings which constitute part of this disclosure limit the present invention. From this disclosure, various alternative embodiments, examples, and operation techniques will be easily found by those skilled in the art.

For example, although in the operation flow shown in FIG. 6, respective judging processes are performed in the order of Steps S101 to S104, the order may be changed. In the operation flow shown in FIG. 6, any of steps S101, S103, and S104 may be omitted.

Similarly, for example, although in the operation flow shown in FIG. 7, respective judging processes are performed in the order of Steps S201 to S204, the order may be changed. In the operation flow shown in FIG. 7, any of steps S201, S203, and S204 may be omitted.

In the embodiment described above, although the radio base station 1A makes a judgment on traffic and application in both uplink and downlink, it may make a judgment on traffic and application in any one of the uplink and downlink.

In the embodiment described above, although a description is given with a header compression protocol by RoHC through example, other header compression protocol using context information (RFC2508; CRTP (Compressed Real Time Protocol) or the like, for example) may substitute it.

In addition, in the embodiment described above, although a configuration based on the UMB system is described, the present invention is not limited to the UMB system and can be applied to any radio communication system, as long as different radio base stations can serve as an uplink radio communication partner and a downlink radio communication partner.

For example, the present invention may be applied to LTE-Advanced which is positioned as the fourth generation (4G) mobile phone system. In a next-generation radio communication system such as LTE-Advanced or the like, specification may be such that a radio terminal can connect to different radio base stations in the uplink and the downlink. In such a specification, it is contemplated that different base stations can serve as the downlink radio communication partner (FLSE) and the uplink radio communication partner (RLSE), as appropriate, not only during a handover. Application of the present invention can avoid the failure which occurs when the uplink radio communication partner and the downlink radio communication partner of the radio terminal are different radio base stations, even in the next-generation radio communication system such as LTE-Advanced.

As described above, it should be understood that the present invention includes various embodiments which are not described herein. Accordingly, the present invention should be limited only by the scope of claims regarded as appropriate based on the description.

Note that the entire content of Japanese Patent Application No. 2008-283750 (filed on Nov. 4, 2008) and Japanese Patent Application No. 2008-283751 (filed on Nov. 4, 2008) are incorporated herein by reference.

### INDUSTRIAL APPLICABILITY

As described above, since the radio base station and the radio communication method according to the present invention can avoid the failure which occurs when an uplink radio communication partner and a downlink radio communication partner of a radio terminal are different base stations, it is useful in radio communications such as a mobile communication or the like.

1. A radio base station that performs radio communications with a radio terminal in a radio communication system allowing different radio base stations to serve as an uplink radio communication partner which is a radio communication partner of the radio terminal in an uplink, and a downlink radio communication partner which is a radio communication partner of the radio terminal in a downlink, the radio base station comprising:
an instruction transmitter configured to transmit to the radio terminal a handover instruction to handover any one of the uplink radio communication partner and the downlink radio communication partner to another radio base station if the radio base station functions as the uplink radio communication partner and the downlink radio communication partner, and also if a running application which is run at the radio terminal and involves radio communications with the radio base station is not a specific application, wherein
the instruction transmitter is configured to omit transmission of the handover instruction if the radio base station functions as the uplink radio communication partner and the downlink radio communication partner, and also if the running application is the specific application.

2. The radio base station according to claim 1, wherein, if the radio base station functions as the uplink radio communication partner and the downlink radio communication partner and also if the running application is not the specific application, the instruction transmitter is configured to transmit to the radio terminal an uplink handover instruction to handover the uplink radio communication partner to another radio base station as the handover instruction when an uplink traffic value indicating an amount of traffic being transmitted and received through the radio base station in the uplink exceeds a predetermined value for congestion in the uplink.

3. The radio base station according to claim 2, further comprising:
an uplink threshold comparator configured to, when the uplink traffic value exceeds the predetermined value, compare the uplink traffic value with an uplink threshold for a type of the specific application if the radio base station functions as the uplink radio communication partner and the downlink radio communication partner, and also if the running application is the specific application, wherein
the instruction transmitter is configured to omit transmission of the uplink handover instruction if the uplink traffic value does not exceed the uplink threshold, and
the instruction transmitter is configured to transmit the uplink handover instruction to the radio terminal if the uplink traffic value exceeds the uplink threshold.

4. The radio base station according to claim 1, wherein, if the radio base station functions as the uplink radio communication partner and the downlink radio communication partner and also if the running application is not the specific application, the instruction transmitter is configured to transmit to the radio terminal a downlink handover instruction to handover the downlink radio communication partner to another radio base station as the handover instruction when a downlink traffic value indicating an amount of traffic being transmitted from the radio base station in the downlink exceeds a predetermined value for congestion in the downlink.

5. The radio base station according to claim 4, further comprising:
a downlink threshold comparator configured to, when the downlink traffic value exceeds the predetermined value, compare the downlink traffic value with a downlink threshold for a type of the specific application if the radio base station functions as the uplink radio communication partner and the downlink radio communication partner, and also if the running application is the specific application, wherein
the instruction transmitter is configured to omit transmission of the downlink handover instruction if the downlink traffic value does not exceed the downlink threshold, and
the instruction transmitter is configured to transmit the downlink handover instruction to the radio terminal if the downlink traffic value exceeds the downlink threshold.

6. The radio base station according to claim 1, wherein the instruction transmitter is configured to transmit the handover instruction to the radio terminal if the radio base station functions as the uplink radio communication partner and the downlink radio communication partner, if the running application is not the specific application, and also if there exists a handover target radio base station which is to serve as a handover target when the radio terminal hands over the uplink radio communication partner or the downlink radio communication partner.

7. The radio base station according to claim 1, wherein
the instruction transmitter is configured to transmit the handover instruction to the radio terminal if the radio base station functions as the uplink radio communication partner, the downlink radio communication partner, and an anchor base station, and also if the running application is not the specific application, and
the anchor base station is a radio base station which receives data addressed to the radio terminal from a communication network in the downlink not through another radio base station.

8. The radio base station according to claim 1, wherein the specific application includes at least one of:
an application using a header compression protocol;
a non-voice real-time application requiring lower delay than a data application; and
a voice real-time application requiring lower delay than the non-voice real-time application.

9. A radio communication method performed by a radio base station that performs radio communications with a radio terminal in a radio communication system allowing different radio base stations to serve as an uplink radio communication partner which is a radio communication partner of the radio terminal in an uplink, and a downlink radio communication partner which is a radio communication partner of the radio terminal in a downlink, the radio communication method comprising the steps of:
transmitting to the radio terminal a handover instruction to handover any one of the uplink radio communication partner and the downlink radio communication partner to another radio base station if the radio base station functions as the uplink radio communication partner and the downlink radio communication partner, and also if a running application which is run at the radio terminal and involves radio communications with the radio base station is not a specific application; and
omitting transmission of the handover instruction if the radio base station functions as the uplink radio communication partner and the downlink radio communication partner, and also if the running application is the specific application.

10. A radio base station that performs radio communications with a radio terminal in a radio communication system allowing different radio base stations to serve as an uplink radio communication partner which is a radio communication partner of the radio terminal in an uplink, and a downlink radio communication partner which is a radio communication partner of the radio terminal in a downlink, the radio base station comprising:
an instruction transmitter configured to transmit to the radio terminal an uplink handover instruction to handover the uplink radio communication partner to another radio base station, if an uplink traffic value indicating an amount of traffic being transmitted and received through the radio base station in the uplink exceeds a predetermined value for congestion in the uplink, and also if the radio base station functions as the uplink radio communication partner and the downlink radio communication partner.

11. The radio base station according to claim 10, wherein the uplink traffic value is the number of all radio terminals for which the radio base station serves as the uplink radio communication partner.

12. The radio base station according to claim 10, wherein the uplink traffic value is an uplink throughput which is an amount of traffic per unit time transmitted to a communication network through the radio base station from all radio terminals for which the radio base station serves as the uplink radio communication partner.

13. The radio base station according to claim 10, wherein the instruction transmitter is configured to transmit the uplink handover instruction to the radio terminal, if there exists a handover target radio base station which is to serve as a handover target when the radio terminal hands over the uplink radio communication partner, if the uplink traffic value exceeds the predetermined value, and also if the radio base station functions as the uplink radio communication partner and the downlink radio communication partner.

14. The radio base station according to claim 10, wherein the instruction transmitter is configured to transmit the uplink handover instruction to the radio terminal if the uplink traffic value exceeds the predetermined value, and also if the radio base station functions as the uplink radio communication partner, the downlink radio communication partner, and an anchor base station, and
the anchor base station is a radio base station which receives data addressed to the radio terminal from a communication network in the downlink not through another radio base station.

15. A radio base station that performs radio communications with a radio terminal in a radio communication system allowing different radio base stations to serve as an uplink radio communication partner which is a radio communication partner of the radio terminal in an uplink, and a downlink radio communication partner which is a radio communication partner of the radio terminal in a downlink, the radio base station comprising:
an instruction transmitter configured to transmit to the radio terminal a downlink handover instruction to handover the downlink radio communication partner to another radio base station, if a downlink traffic value indicating an amount of traffic being transmitted from the radio base station in the downlink exceeds a predetermined value for congestion in the downlink, and also if the radio base station functions as the uplink radio communication partner and the downlink radio communication partner.

16. The radio base station according to claim 15, wherein the downlink traffic value is the number of all radio terminals for which the radio base station serves as the downlink radio communication partner.

17. The radio base station according to claim 15, wherein the instruction transmitter is configured to transmit the downlink handover instruction to the radio terminal, if there exists a handover target radio base station which is to serves as a handover target when the radio terminal hands over the downlink radio communication partner, if the downlink traffic value exceeds the predetermined value, and also if the radio base station functions as the uplink radio communication partner and the downlink radio communication partner.

18. The radio base station according to claim 15, wherein the instruction transmitter is configured to transmit the downlink handover instruction to the radio terminal if the downlink traffic value exceeds the predetermined value, and also if the radio base station functions as the uplink radio communication partner, the downlink radio communication partner, and an anchor base station, and
the anchor base station is a radio base station which receives data addressed to the radio terminal from a communication network in the downlink not through another radio base station.

19. A radio communication method performed by a radio base station that performs radio communications with a radio terminal in a radio communication system allowing different radio base stations to serve as an uplink radio communication partner which is a radio communication partner of the radio terminal in an uplink, and a downlink radio communication partner which is a radio communication partner of the radio terminal in a downlink, the radio communication method comprising the steps of:
transmitting to the radio terminal an uplink handover instruction to handover the uplink radio communication partner to another radio base station, if an uplink traffic value indicating an amount of traffic being transmitted and received through the radio base station in the uplink exceeds a predetermined value for congestion in the uplink, and also if the radio base station functions as the uplink radio communication partner and the downlink radio communication partner.

20. A radio communication method performed by a radio base station that performs radio communications with a radio terminal in a radio communication system allowing different radio base stations to serve as an uplink radio communication partner which is a radio communication partner of the radio terminal in an uplink, and a downlink radio communication partner which is a radio communication partner of the radio terminal in a downlink, the radio communication method comprising the steps of:
transmitting to the radio terminal a downlink handover instruction to handover the downlink radio communication partner to another radio base station, if a downlink traffic value indicating an amount of traffic being transmitted from the radio base station in the downlink exceeds a predetermined value for congestion in the downlink, and also if the radio base station functions as the uplink radio communication partner and the downlink radio communication partner.
